(19) United States
(12) Patent Application Publication
(10) Pub. No.: US 2009/0016230 A1
(43) Pub. Date: Jan. 15, 2009

(54) METHOD AND APPARATUS FOR EXCHANGING SERVICE CAPABILITY INFORMATION OF USER EQUIPMENT

(75) Inventor: Chi Won Choi, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/166,970

(22) Filed: Jul. 2, 2008

(30) Foreign Application Priority Data
Jul. 13, 2007 (KR) 2007-0070528

(51) Int. Cl. H04L 12/26

(52) U.S. Cl. 370/252

(57) ABSTRACT

A technology for exchange of information about the capability of a multimedia service supportable by user equipment in a network supporting the multimedia service is provided. A method for exchanging service capability information in a network supporting a multimedia service includes monitoring for a change in service capability of a first user equipment, transmitting information about the service capability of the first user equipment to a second user equipment, upon detecting the change in the service capability and informing a user of a service capability of the second user equipment, upon reception of a message informing of a change in the service capability of the second user equipment from the second user equipment. Using the updated service capability information, communication resources are more efficiently used.

### PRIORITY

This application claims the benefit under 35 U.S.C. §119(a) of a Korean patent application filed in the Korean Intellectual Property Office on Jul. 13, 2007 and assigned Serial No. 2007-0070528, the entire disclosure of which is hereby incorporated by reference.

### BACKGROUND OF THE INVENTION

1. Field of the Invention

The present invention relates to technology for the exchange of service capability information. More particularly, the present invention relates to a technology for the exchange of information about the capability of a multimedia service supportable by user equipment in a network supporting the multimedia service.

2. Description of the Related Art

Typically, voice services in a mobile communication network are provided by a Circuit Switched (CS) network. In such a CS network, a fixed communication path is created between a user and a counterpart. In recent years, IP Multimedia Subsystem (IMS) networks, in which data services are provided based on an Internet Protocol (IP) for transmission and reception of packet data, have been introduced to replace CS networks for typical voice services. Such an IMS network uses a Packet Switched (PS) and unfixed communication path based on IP, which enhances the transmission rate of data as well as the security and safety of the data.

In a conventional IMS network, information regarding the service capability of a first user equipment (i.e. information about a multimedia service that the first user equipment can support) is transmitted to a counterpart user equipment. The first user equipment transmits the information at an initial stage of a multimedia service to inform the counterpart user equipment of which multimedia services are supported by the first user equipment. Similarly, information about the service capability of the counterpart user equipment is received by the first user equipment from the counterpart user equipment. The process of transmitting and receiving symmetrical service information between user equipments is referred to as a service capability exchanging process. User equipments may be informed of supportable services through the service capability exchanging process and may execute a desired service based on the exchanged information.

However, in an IMS network providing a service using an unfixed wireless network, the services that are supportable by a first user equipment may change. For example, the supported services may change according to the type of the wireless network connected to the user equipment and the type of service. Further, if the first user equipment supports a multimedia service, a supportable service may be changed according to the user's behavior. Moreover, the services supportable by user equipment may change by one of the above-mentioned factors after the service capabilities of user equipments are exchanged at the initial stage of a service. Despite the changes that may occur in the services that are supported by the user equipment, the service capability exchanging process is generally carried out only once at the initial stage of a service. Therefore, even when a service supportable by a first User Equipment (UE1) is changed after the service capability exchanging process is initially carried out, a second or counterpart User Equipment (UE2) is not informed of the change. As a result, the UE2 may demand a service from the UE1 which the UE1 no longer supports. The UE2 does not recognize that the demanded service is not supported by the UE1 until it is informed that the demanded service is no longer supported by the UE1. Accordingly, since the UE2 does not have knowledge of the changed service, it may attempt an unnecessary process. Once the UE2 is aware that the UE1 no longer supports the demanded service, the UE2 stores information about the demanded service as one that cannot be supported by the UE1. However, based on changing circumstances of the UE1, there may be an occasion in which the UE1 can support the service again. In this case, the UE2 still recognizes that the UE1 cannot continue the service based on the previously stored information and does not make a demand for the service, causing inefficient use of the service. Furthermore, assuming that the UE2 does not store information about a service that is no longer supported by the UE1, the UE2 may continuously make a demand for the unsupported service from the UE1 and deteriorate the UE2's convenience of use.

### SUMMARY OF THE INVENTION

An aspect of the present invention is to address at least the above-mentioned problems and/or disadvantages and to provide at least the advantages described below. Accordingly, an aspect of the present invention is to provide a technology for transmitting information about a service supportable by a user equipment when the supportable service is changed.

In accordance with an aspect of the present invention, a method for exchanging service capability information in a network supporting a multimedia service is provided. The method includes monitoring for a change in service capability of a first user equipment, transmitting service capability information of the first user equipment to a second user equipment, upon detecting the change in the service capability and informing a user of service capability information of the second user equipment, upon reception of a message informing of a change in the service capability of the second user equipment from the second user equipment.

In accordance with another aspect of the present invention, an apparatus in a first user equipment for exchanging service capability information in a network supporting a multimedia service between the first user equipment and a second user equipment is provided. The apparatus includes a communication unit for executing a service with the second user equipment, a capability checker for checking for a change in service capability information, upon a change in service capability, for transmitting the changed service capability information to the second user equipment, and upon a change in service capability of the second user equipment, for receiving changed service capability information of the second user equipment from the second user equipment, an event manager for monitoring for an occurrence of a change in service capability and a service informer for, upon occurrence of the event, informing a user of the changed service capability.

The above-mentioned characteristics and technical advantages of aspects of the present invention have been widely and briefly described so that any person skilled in the art can easily understand the present invention from the following description of exemplary embodiments of the present invention. Therefore, additional characteristics and technical advantages of the present invention that define features of claims of the present invention will be easily understood together with the above-mentioned ones.

As mentioned above, according to exemplary embodiments of the present invention, accurate information of a supportable service can be provided to a user by informing a counterpart user equipment of change in service capability whenever service capability is changed in a wireless network where service capability may be easily changed. Therefore, a user is prevented from making a demand for an unsupportable service and is promptly provided with restored supportable service information, so that service efficiency can be enhanced.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a view illustrating a mobile communication network according to an exemplary embodiment of the present invention;

FIGS. 2A to 2C are sequence diagrams illustrating a service capability information exchanging process between user equipments according to an exemplary embodiment of the present invention;

FIG. 3 is a view illustrating a user equipment according to an exemplary embodiment of the present invention; and

FIGS. 4A and 4B are flowcharts illustrating a process of transmitting support service information according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. The meaning of specific terms or words used in the specification and the claims should not be limited to the literal or commonly employed sense, but should be construed in accordance with the spirit of the invention. Also, detailed descriptions of well-known functions and constructions are omitted for clarity and conciseness.

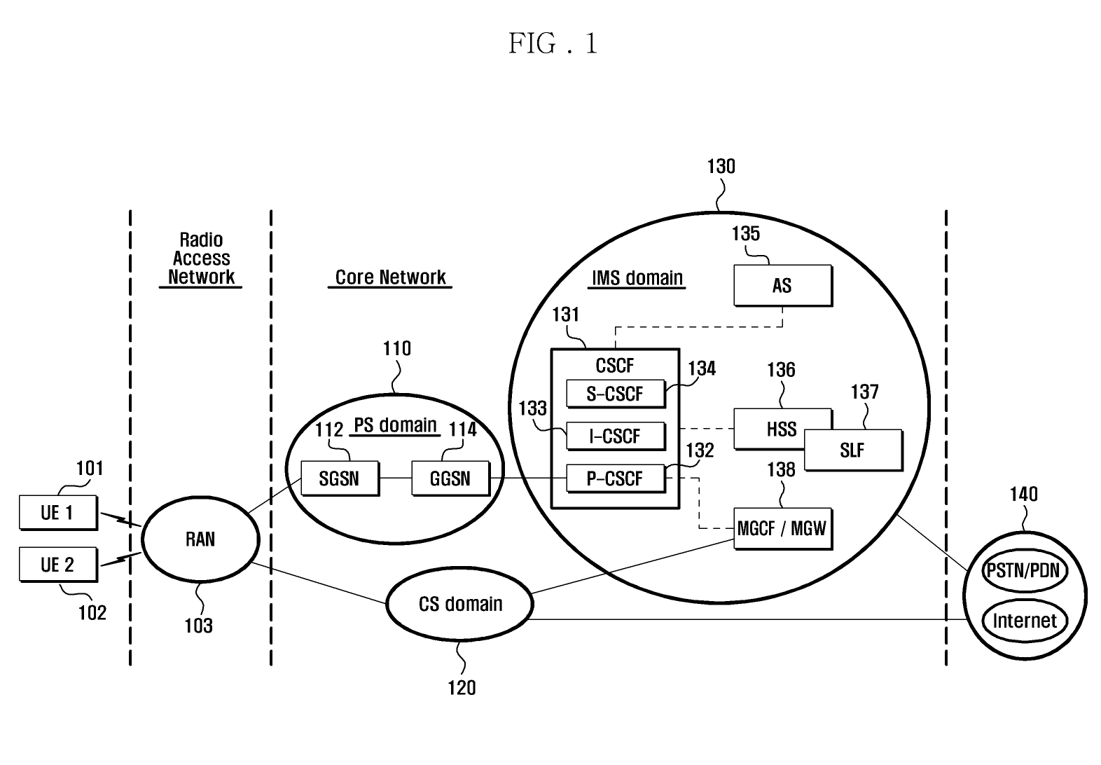

FIG. 1 is a view illustrating a mobile communication network according to an exemplary embodiment of the present invention. Hereinafter, a Universal Mobile Telecommunication Service (UMTS) mobile communication network based on Global System for Mobile communications (GSM) and General Packet Radio Services (GPRS) will be described below. Of course, it is noted that these communication systems are chosen merely for example and the specific technical fields and titles used in the description do not limit the scope of the present invention.

Referring to FIG. 1, a mobile communication network according to an exemplary embodiment of the present invention includes a Radio Access Network (RAN) 103 and a Core Network (CN). The RAN 103 connects a first User Equipment (UE1) 101 and a second User Equipment (UE2) 102 to the CN. Because the wireless connection technology used in the RAN is well known in the art, a detailed description thereof will be omitted for conciseness.

The CN may include a Packet Switched (PS) domain 110, a Circuit Switched (CS) domain 120 and an IP Multimedia Subsystem (IMS) domain 130. The CS domain 120 includes network entities (not shown) supporting CS calls and handles a CS call processing procedure.

The PS domain 110 supports a packet-based service and may include a Serving GPRS Support Node (SGSN) 112 and a Gateway GPRS Support Node (GGSN) 114. The SGSN 112 manages position information of the UE1 and UE2 and performs security-related functions and access control. The GGSN 114 is an element of a GPRS network which functions as a wireless gateway between the SGSN 112 and external networks 140 such as a Packet Data Network (PDN), and the UE1 and the UE2 may be connected to the PDN using the GGSN 114.

The IMS domain 130 includes network entities supporting an IMS session. A packet exchange service such as transmission of a message or a file is carried out through the IMS session. The network entities supporting the IMS session may include a Call Session Control Function (CSCF) 131, an Application Server (AS) 135, a Home Subscriber Server (HSS) 136, a Subscriber Locator Function (SLF) 137, and a Media Gateway Control Function (MGCF)/Media Gateway (MGW) 138. The CSCF 131 carries out a registration/multimedia call processing function using a Session Initiation Protocol (SIP), and includes a Proxy-Call Session Control Function (P-CSCF) 132, an interrogating-call Session Control Function (I-CSCF) 133, and a Serving-Call Session Control Function (S-CSCF) 134. The P-CSCF 132 is the first contact point for connection to the IMS network and transfers a message received from a UE to the I-CSCF 133 pertaining to the network corresponding to the user equipment. The I-CSCF 133 searches for an S-CSCF 134 corresponding to a UE and transfers a message to the S-CSCF 134. The S-CSCF 134 sets the IMS session and receives and processes an IMS-related SIP message transferred from a UE. In order to provide a service demanded by a UE, the S-CSCF 134 transfers an SIP message to the entities in the IMS domain to finish the session and enables the UE demanding the service to receive the service. The SIP message includes an invitation for starting the SIP session, an acknowledgement expressing an acceptance of a call by a receiver side, and an option making a demand for a response using functions of a transmitter side. Hereinafter, for the sake of convenience, only messages related to exchange of IMS service capability information will be described. That is, only the option containing supportable multimedia service information and a 200 OK message expressing a response of a receiver side will be described.

The AS 135 facilitates applications such as e-mail, and the HSS 136 integrates functions for management and certification of mobility of an IP multimedia user with functions of a home locator register HLR of a conventional mobile communication network to perform the functions. The SLF 137 provides information about a position of the S-CSCF 134 to which a UE pertains when there is one or more HSSs 136. The MGCF/MGW 138 is a network entity that enables communication between an IMS user and a CS user, and includes an MGCF, i.e. a gateway in charge of signaling conversion for association between an IMS network and an existing network, e.g. a Public Switched Telephone Network (PSTN) and an IMS-MGW for conversion of media. Although not illustrated, in considering optimized routing of CS calls, the MGCF/MGW 138 may further include a Breakout Gateway Control Function (BGCF), i.e. a network entity selecting the optimum MGCF that is a contact point connected to the CS domain 110. That is, the BGCF may be provided in the MGCF/MGW 138. Entities other than the above-mentioned entities may exist in domains according to their functions.

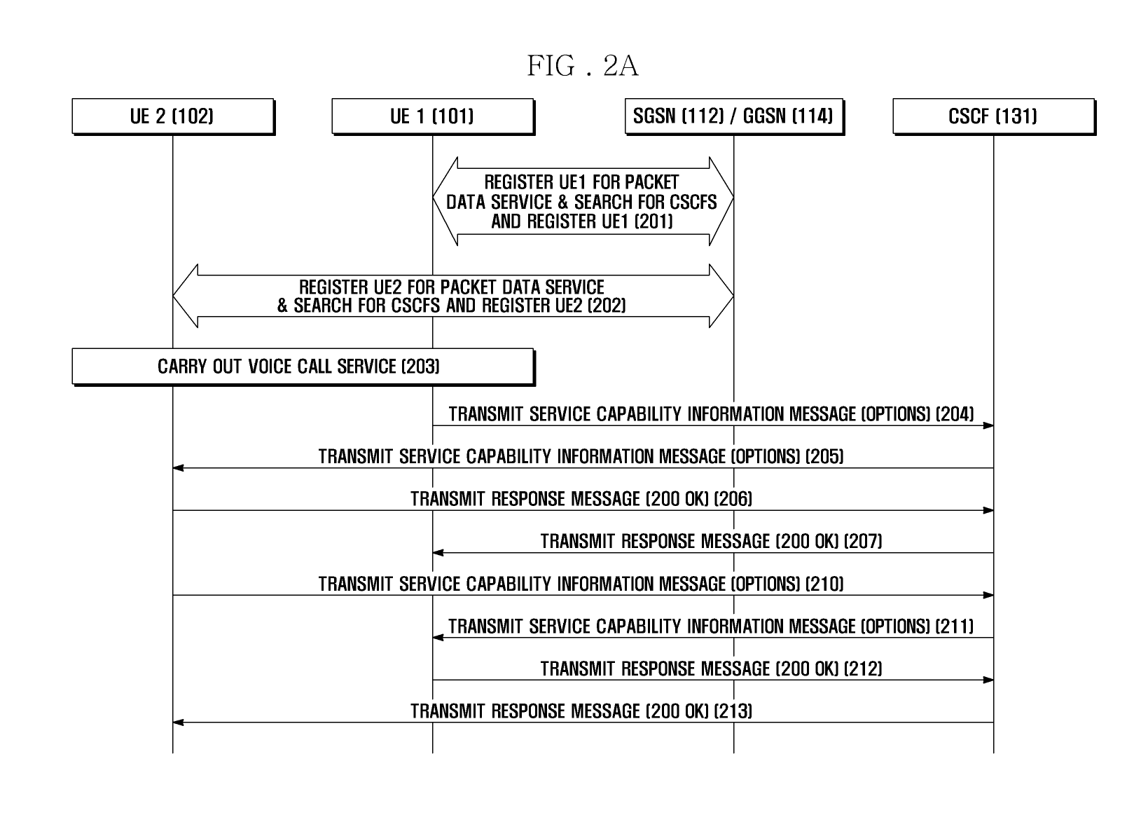

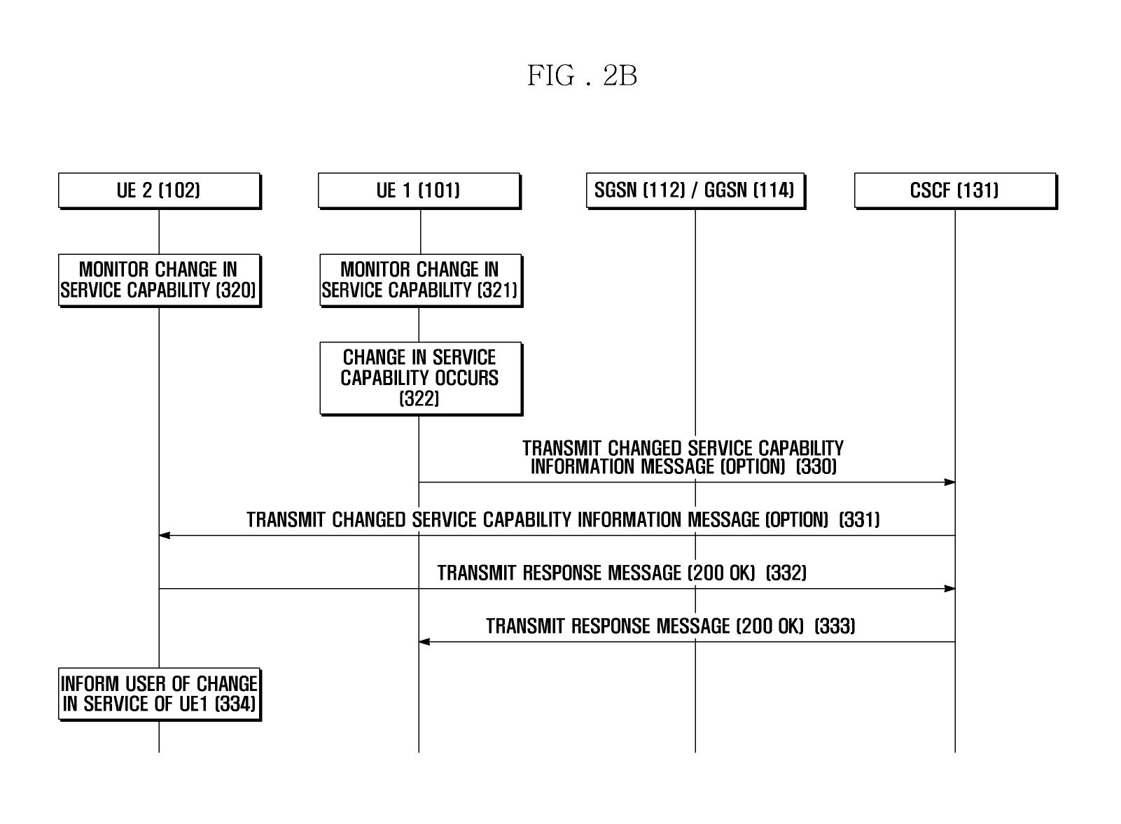

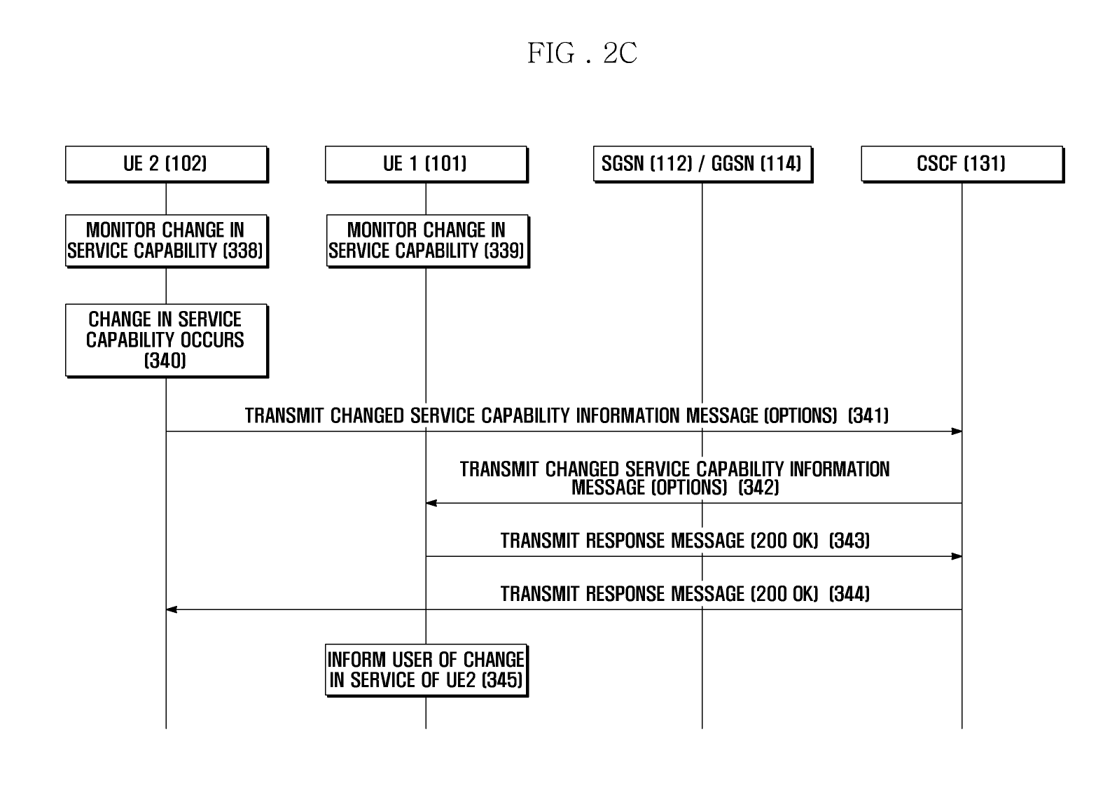

An exemplary initial process of exchanging service capability information between a UE making a demand for a service and another UE from which the demand for a service is made will be described with reference to FIGS. 2A to 2C.

FIGS. 2A to 2C are sequence diagrams illustrating a service capability information exchanging process between user equipments according to an exemplary embodiment of the present invention. In FIGS. 2A to 2C, it is assumed that both a UE1 101 and a UE2 102 support multimedia service, the UE1 101 is a user equipment making a demand for a service, and the UE2 102 is a user equipment from which the demand for the service is made. It is also assumed that the UE1 101 and the UE2 102 are based on a UMTS and support a GSM. It is also assumed that the UE1 and the UE2 support both 2G and 3G mobile communications. It is understood that these assumptions are made merely to assist in explaining an exemplary embodiment of the invention and are not to be construed as limiting.

FIG. 2A is a sequence diagram illustrating an initial process of exchanging service capability information between user equipments. In steps 201 and 202, the UE1 101 and the UE2 102 respectively carry out a procedure for their registrations in entities of the PS domain for a packet data service. More particularly, the UE1 101 and the UE2 102 transfer activation messages to the SGSN 112 and the GGSN 114 in the PS domain upon switching on or setting of a power source. The transferred messages generally use Packet Data Protocol (PDP) activation messages, which contain information necessary for a packet data service such as IP information of user equipments transferring messages. The UE1 101 and the UE2 102 are registered in the SGSN 112 and the GGSN 114 through the procedure. The UE1 101 and the UE2 102 supporting multimedia service search for information about CSCFs 131 of networks to which the UE1 101 and the UE2 102 pertain respectively and register themselves. That is, the UE1 101 and the UE2 102 search for information about the CSCFs 131 or, in particular, position information of the P-CSCFs 132 corresponding to them and register themselves in the corresponding CSCFs 131. The registration for the IMS service may be carried out when a power source of a user equipment is switched on or when a demand for the IMS service is made. For the sake of convenience, the illustrated example includes a procedure for IMS service related registration that is carried out together with a procedure for registration in the PS domain.

In addition to step 201 and 202, the UE1 101 and the UE2 102 carry out a voice call service connecting voice calls through the CS domain 120 in step 203. According to an exemplary implementation, when service capability is changed in one user equipment during performance of a voice call service between two user equipments, service capability information is changed and is transmitted to the other user equipment. Accordingly, it is regarded that the voice call connected in step 203 remains continuously connected and serviced from step 203 of FIG. 2A to FIGS. 2B and 2C.

In step 204, the UE1 101 making a demand for a service transmits service capability information, i.e. a multimedia service information message supportable by the UE1 101 to the CSCF 131. The service information may include video share information, i.e. a parameter expressing the possibility of a video service or image share, or a parameter expressing the possibility of an image service. As illustrated in FIG. 1, the CSCF 131 includes the P-CSCF 132, the I-CSCF 133, and the S-CSCF 134, in which case a message transmitted from the UE1 101 to the CSCF 131 is processed in the CSCF 134 while it is passing through the three CSCFs 132, 133, and 134. More particularly, in processing of a message in the three CSCFs 132, 133, and 134, the message transmitted from the UE1 101 is transferred to the P-CSCF 132, i.e. the first connection point of the IMS network, which transfers the message to the S-CSCF 134 to process the message. The S-CSCF 134 processes the received message, transmits the message to the I-CSCF 133 of a network to which the UE2 pertains, and transmits the message to the UE2 102 from which a demand for a service is made. Then, a Domain Name System (DNS) may be referred to in order to monitor the position of an I-CSCF 133 corresponding to the UE1 101 and the UE2 102. The I-CSCF 133 that received the message may refer to the HSS 137 to inform an S-CSCF 134 corresponding to the UE2 102. Then, in case of two or more HSSs 136, the SLF 137 may be referred to for information about the HSSs 136. After reference to the S-CSCF 134, the I-CSCF 133 transfers the message to the S-CSCF 134 corresponding to the UE2 102. The S-CSCF 134 that received the message processes the message, then transmits the message to the P-CSCF 132 to transmit it to the UE 2 102.

In step 205, the CSCF 131 or, in particular, the P-CSCF 132 transmits a service capability information message, i.e. a supportable multimedia service information message of the UE1 101 to the UE2 102. In step 206, the UE2 102 that received the message transmits a response message 200 OK to a CSCF 131. The CSCF 131 corresponding to the UE2 102 that received the response message transmits the response message to the CSCF 131 corresponding to the UE1 101. In step 207, the CSCF 131 corresponding to the UE1 101 transmits the response message to the UE1 101. Through the steps, the UE1 101 that made a demand for a service provides the UE2 102 with information of a multimedia service that the UE1 101 can support so that the UE2 102 is informed of which multimedia service is supportable by the UE1 101.

The UE2 102 performs a message transmitting step, similar to the above-mentioned message transmitting step of the UE1 101, to provide the UE1 with information about a multimedia service that the UE2 102 can support. That is, in step 210, the UE2 102 transmits a message OPTIONS containing service capability information to the CSCF 131. The CSCF 131 corresponding to the UE1 102 that received a message transmits the message to the CSCF 131 corresponding to the UE1 101 to transmit the message to the UE1 101. The steps of processing the message while the message is passing through the P-CSCF 132, the I-CSCF 133, and the S-CSCF 134 are similar to the above-mentioned steps of processing the information message transmitted by the UE1 101.

In step 211, the CSCF 131 corresponding to the UE1 101 transmits the information message to the UE1 101. In step 212, the UE1 101 transmits a response message 200 OK to the received message to the CSCF 131. The CSCF 131 confirms the position of the CSCF 131 corresponding to the UE2 102 and transmits the response message to the CSCF 131 corresponding to the UE2 102. In step 213, the CSCF 131 corresponding to the UE2 102 transmits the response message to the UE2 102. Accordingly, the information about the multimedia service supportable by the UE2 102 is transferred to the UE1 101, and then the UE1 101 is also informed of which multimedia service is supportable by the UE2 102.

Referring to FIG. 2B, after exchanging the initial service capability information, in steps 320 and 321, the UE1 101 and the UE2 102 respectively monitor for any changes in their current service capability. The monitoring continues during the duration of a connected service, for example a voice call service. FIG. 2B illustrates an example of a change in service capability of the UE1 101, and FIG. 2C illustrates an example of a change in service capability of the UE2 102. According to an exemplary embodiment of the present invention, whenever a change in service capability occurs, service capability information is changed and is provided to a counterpart user equipment. By providing the changed service capability information to the counterpart user, a conventional problem caused by carrying out only the initial service capability exchanging process of FIG. 2A is addressed.

In step 322, a change in service capability occurs in the UE1 101. Based on the change in service capability, the UE1 101 transmits a message OPTIONS, including information about the service capability that has been changed, to a CSCF 131 in step 330. As mentioned above, the CSCF 131 that receives the message from the UE1 101 transmits the message to a CSCF 131 corresponding to the UE2 102, and the CSCF 131 corresponding to the UE2 102 transmits the message to the UE2 102 in step 331. Then, the UE2 102 transmits a response message 200 OK to a specific CSCF 131 in step 332 and the specific CSCF 131 transmits the response message to the UE1 101 in step 333. In this case, when the specific CSCF 131 is one for transmission and reception of a message to and from the UE1 101, it refers to a CSCF pertaining to the UE1 101, but when the specific CSCF 131 is one for transmission and reception of a message to and from the UE2 102, it refers to a CSCF pertaining to the UE2 102. In step 334, the UE2 102 that was informed of the change in the service capability of the UE1 101 informs a user of the change in the service capability of the UE1 101. For example, the UE2 102 may display a message on a display unit so that information about a supportable multimedia service can be accurately provided to a user when the user makes a demand for a service.

There may also occur a change in service capability in a user equipment from which a demand for a service is made, as well as in a user equipment making a demand for a service. FIG. 2C illustrates an example of a change in service capability in the UE2 102 from which a demand for a service is made. The UE2 102 and the UE1 101 respectively monitor for changes in their current service capability in steps 338 and 339. The monitoring continues during the duration of a connected service, for example a voice service. When a change in the service capability of the UE2 102 occurs in step 340, the UE2 102 transmits a message OPTIONS, containing information about the service capability that has been changed, to a CSCF 131 in step 341. As mentioned above, the CSCF 131 transmits the message to a CSCF 131 corresponding to the UE1 101, and the CSCF 131 corresponding to the UE1 101 transmits the message to the UE1 101 in step 342. Then, the UE1 101 transmits a response message 200 OK to a specific CSCF 131 in step 343 and the specific CSCF 131 transmits the response message to the UE2 102 in step 344. In this case, when the specific CSCF 131 is one for transmission and reception of a message to and from the UE1 101, it refers to a CSCF pertaining to the UE1 101, but when the specific CSCF 131 is one for transmission and reception of a message to and from the UE2 102, it refers to a CSCF pertaining to the UE2 102. In step 345, the UE1 101 that has been informed of the change in the service capability of the UE2 102 informs a user of the change in the service capability of the UE2 102. For example, the UE1 101 may display a message on a display unit, so that information about a supportable multimedia service can be accurately provided to a user when the user makes a demand for a service.

A change in service capability may be caused due to a change in Radio Access Technology (RAT) or a change in call status. RAT refers to, for example, Wideband-Code Division Multiplex Access (W-CDMA) technology in a Universal Mobile Telecommunication Service (UMTS), i.e. a 3G mobile communication system, and Radio Frequency (RF) communication such as Time Division Multiple Access (TDMA) technology in a Global System for Mobile telecommunication (GSM). There may occur a change in RAT. For example, a user equipment previously located in a UMTS network may move to a GSM network. There may also occur a change in call status. For example, voice call services of a UE1 and a UE2 may be delayed when a third User Equipment (UE3) makes a demand for a voice call service from the UE2 and the UE2 executes a service with the UE3 during execution of a voice call service between the UE1 and the UE2. The above-mentioned scenarios are examples in which a supportable multimedia service is changed to an unsupportable one, or vice versa.

Hereinafter, an exemplary operation of handling the above-mentioned changes in service by elements of a user equipment will be described in more detail.

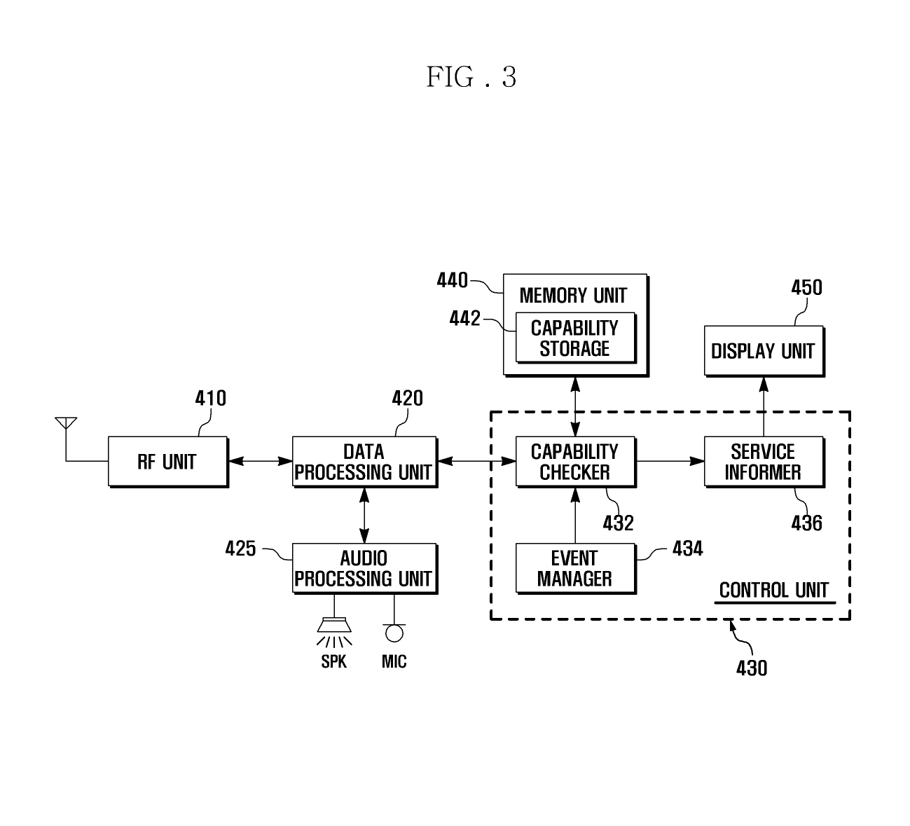

FIG. 3 is a view illustrating a user equipment according to an exemplary embodiment of the present invention. The user equipment may additionally include elements other than those illustrated in FIG. 3, but descriptions of the elements other than those for exchange of service capability information are omitted for clarity and conciseness. Referring to FIG. 3, an RF unit 410 executes wireless communication of the user equipment. The RF unit 410 includes an RF transmitter for converting and amplifying the frequency of a transmitted signal and an RF receiver for low-noise amplifying and converting a received signal. A data processing unit 420 includes a transmitter for coding and modulating a transmitted signal and a receiver for demodulating and decoding a received signal. That is, the data processing unit 420 may include a modem and a codec. The codec includes a data codec for processing packet data and an audio codec for processing an audio signal of a voice. The audio processing unit 425 plays back a received audio signal output from the audio codec of the data processing unit 420 through a speaker (SPK) or transmits an audio signal generated from a microphone (MIC) to the audio codec of the data processing unit 420. In an exemplary implementation of the present invention, when user equipments carry out a voice call service with each other, an audio signal input from a microphone (MIC) is transferred to the audio codec or an audio signal output from the audio codec is played back through the speaker (SPK).

A control unit 430 controls the overall operation of the user equipment. In particular, the control unit 430 includes a capability checker 432, an event manager 434, and a service informer 436 to determine the capability of a service supportable by the user equipment and, upon change in service capability, inform a user of the change in service capability. More particularly, the capability checker 432 determines the service capability of its own service, provides the service capability to a capability storage 442 to allow the capability storage 442 to store it, and provides the service capability to the service informer 436 to allow a display unit 450 to display it.

A memory unit 440 may include a program memory and a data memory. The program memory stores an operating program of the user equipment and the data memory stores data created during operation of the program. The memory unit 440 includes the capability storage 442, which stores service capability information of the user equipment that is provided from the capability checking unit 432, and also stores service capability information of a counterpart user equipment.

The display unit 450 is provided to display information concerning operation of the user equipment in general and specifically about a supportable multimedia service when the user makes a demand for a service. The display unit 450 may be provided as a Liquid Crystal Display (LCD). In this case, the display unit 450 may include a controller for controlling the LCD, a video memory in which image data is stored and an LCD element. If the LCD is provided as a touch screen, the display unit 450 may also function as an input unit.

The event manager 434 monitors for an occurrence of a change event. A change event refers to a factor that causes a change. For example, a change event is determined to occur when a change in RAT or call status occurs during execution of a voice call service, as in FIGS. 2A to 2C. When a change event occurs, the event manager 434 informs the capability checker 432 of occurrence of the event. Then, the capability checker 432 determines the changed service capability and provides it to the service informer 436. The service informer 436 provides the changed service capability to the display unit 450 and the display unit 450 displays the changed service information to inform a user.

According to an exemplary implementation of the present invention, when a change event occurs, service capability information is changed and is provided to a user, and at the same time, is transmitted to a counterpart terminal executing a service. The changed service capability information is transmitted from the capability checker 432, via the data processing unit 420 and the RF unit 410, through the process of FIGS. 2B and 2C, as applicable. For example, the user equipment informs a counterpart terminal of capability information of a multimedia service that cannot be supported any more (i.e. a changed multimedia service) and thus making it impossible for a user to make a demand for the changed multimedia service.

The capability checker 432 provides the changed service capability to the capability storage 442 so that the information may be stored.

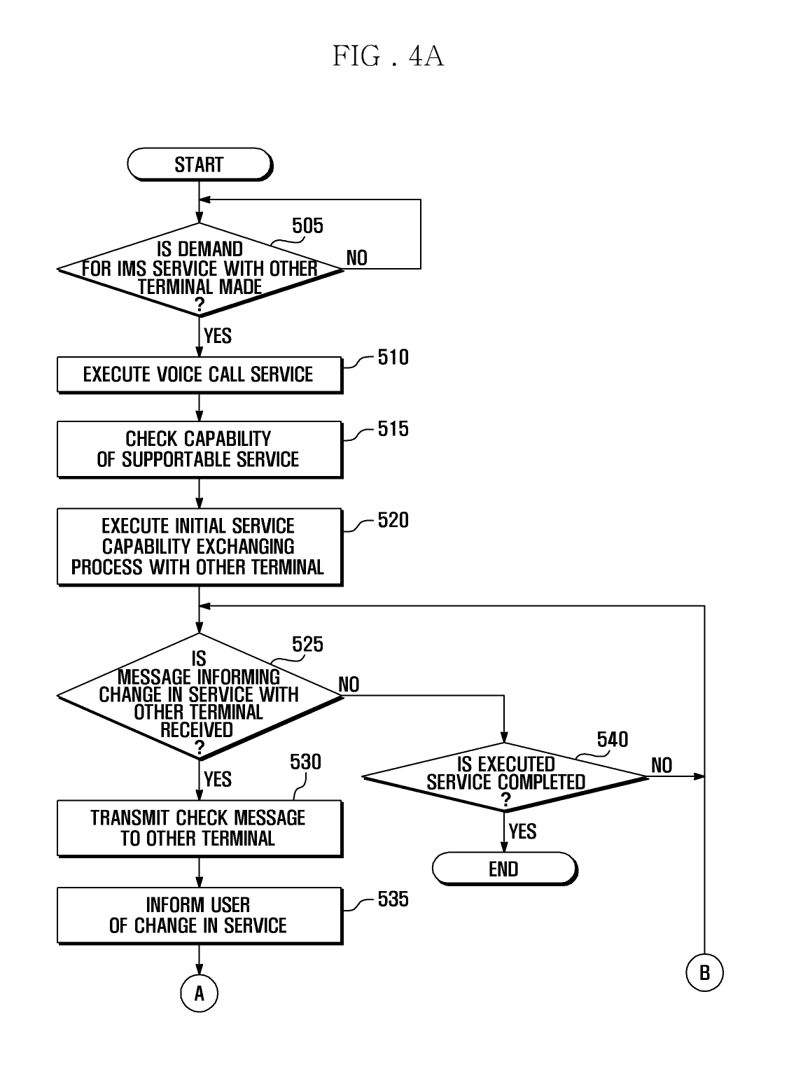

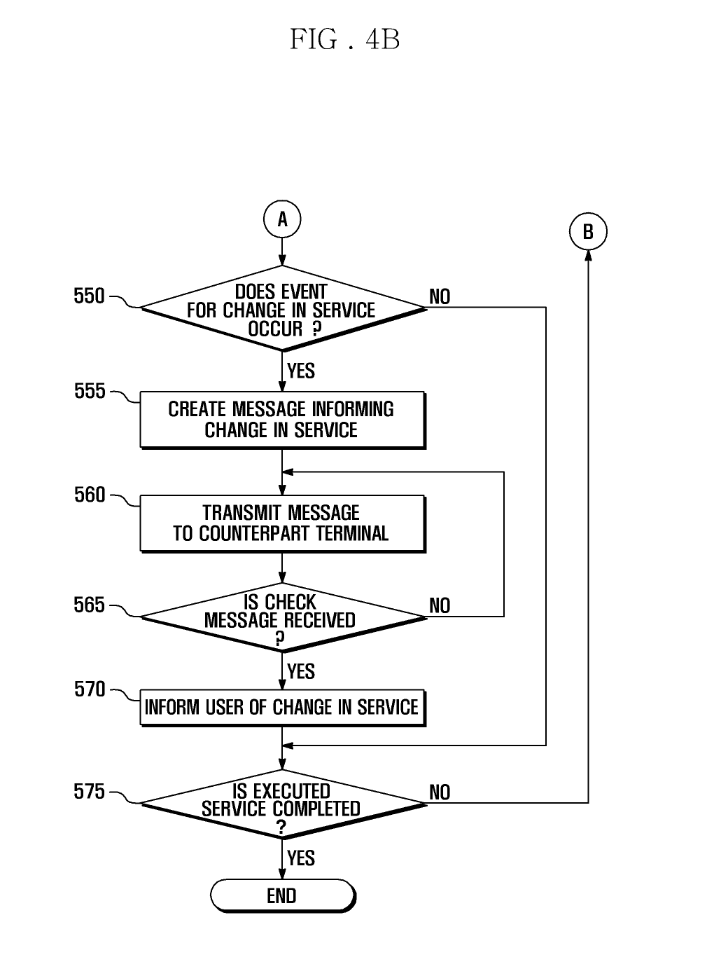

As mentioned above, upon reception of service capability information of a counterpart user equipment through a service capability exchanging process, the capability checker 432 provides the service capability information of the counterpart user equipment to the capability storage 442 so that the information may be stored. Then, upon reception of a message informing of a change in the service capability of the counterpart user equipment, the capability checker 432 provides the changed service capability information of the counterpart user equipment to the service informer 436 and the capability storage 442. The service informer 436 allows the display unit 450 to display the changed service capability information, and the capability storage 442 stores the changed service capability information. Whenever service capability information is changed, a user can confirm accurate information of a supportable multimedia service by provision of the changed information. Hereinafter, a process of transmitting information about a supportable service will be described with reference to FIGS. 4A and 4B.

FIGS. 4A and 4B are flowcharts illustrating a process of transmitting support service information according to an exemplary embodiment of the present invention. The exemplary process illustrated in FIGS. 4A and 4B demonstrates a change in a supportable multimedia service during execution of a voice call service after the voice call service has been requested and established.

Referring to FIGS. 4A and 4B, the control unit 430 of FIG. 3 determines if a user requests a service with a counterpart user equipment in step 505. In this case, both a user equipment making a demand for a service and a user equipment from which the demand for the service is made are assumed to support a multimedia service. The demanded service may be a voice call service for connection of a voice call, a multimedia service and the like.

When a demand for service with another user equipment is made in step 505, the control unit 430 executes the service with the other user equipment, e.g. a voice call service, in step 510. In step 515, the control unit 430 or, in particular, the capability checker 432 checks service capability information. The service capability information is information about a supportable multimedia service and, in this example, contains information about the supportability of a video service. In step 520, the control unit 430 transmits the service capability information to the other user equipment and carries out an initial service capability exchanging process of receiving service capability information of the other user equipment. In an exemplary implementation, the initial service capability exchanging process is the same as illustrated in FIG. 2A.

In step 525, the control unit 430 determines if a message informing of a change in a service capability is received from the other user equipment. Upon reception of a message informing of a change in a service capability, the control unit 430 proceeds to step 530. On the other hand, when a message informing of a change in service capability has not been received, the control unit 430 determines if an executed service has been completed in step 540. In the case of completion of the executed service, the control unit 430 completes a service, i.e. a voice call service, and the process is ended. Otherwise, the control unit returns to step 525. In step 530, the control unit 430 transmits a message in response to the received message informing of the change in service capability to the other terminal. In step 535, the control unit 430 or, in particular, the service informer 436 informs a user of the change in the service capability of the other user equipment through the display unit 450.

Referring to FIG. 4B, in step 550, the control unit or, in particular, the event manager 434 determines if a change event occurs. Upon occurrence of a change event, the control unit 430 proceeds to step 555 or otherwise proceeds to step 575 and determines if the executed service has been completed. If the control unit 430 or, in particular, the capability checker 432 detects a change in a service capability in step 550 a message OPTIONS is created for informing of the change in service capability in step 555. In step 560, the control unit 430 transmits the created message to the other user equipment. In step 565, the control unit 430 determines if a response message to the transmitted message is received from the other user equipment. When a response message to the transmitted message has not been received, the control unit 430 returns to step 560 and transmits the message again. Upon reception of a response message from the other terminal, the control unit 430 proceeds to step 570 and informs a user of the changed service capability. In step 575, the control unit 430 determines if the executed service is completed. If the executed service is completed, the control unit 430 completes the executed voice call service and the process is ended. Otherwise, the controller returns to step 525.

Exemplary embodiments of the present invention enable prevention of waste due to a demand for an unsupportable service by informing a user of the supportability of a multimedia service that can be changed according to the state of a wireless network whenever the supportability is changed. Furthermore, exemplary embodiments of the present invention enable reduction of inefficiency of not making a demand for a supportable service due to recognition of the service as an impossible service in spite of recovery of supportability.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. A method for exchanging service capability information in a network supporting a multimedia service, the method comprising:
monitoring for a change in service capability of a first user equipment;
transmitting service capability information of the first user equipment to a second user equipment upon detecting the change in the service capability; and
informing a user of the first user equipment of a service capability of the second user equipment, upon reception of a message informing of a change in the service capability of the second user equipment from the second user equipment.

2. The method of claim 1, wherein the monitoring for the change in service capability comprises monitoring the first user equipment for its support of a multimedia service.

3. The method of claim 1, wherein the monitoring for the change in service capability comprises monitoring for a change in a Radio Frequency (RF) communication scheme of the first user equipment.

4. The method of claim 1, wherein the monitoring for the change in service capability comprises monitoring for a delay in a voice call service of the first user equipment.

5. The method of claim 1, wherein the service capability information comprises information about a supportable multimedia service.

6. The method of claim 2, further comprising displaying the changed service capability information of the second user equipment on a display unit of the first user equipment.

7. An apparatus in a first user equipment for exchanging service capability information in a network supporting a multimedia service between the first user equipment and a second user equipment, the apparatus comprising:
a communication unit for executing a voice call service or a multimedia service with the second user equipment;
a capability checker for checking for a change in service capability information, upon a change in service capability, for transmitting the changed service capability information to the second user equipment, and upon a change in service capability of the second user equipment, for receiving changed service capability information of the second user equipment from the second user equipment;
an event manager for monitoring for an occurrence of a change in service capability; and
a service informer for, upon occurrence of the event, informing a user of the changed service capability.

8. The apparatus of claim 7, wherein the service capability is changed when a support for the multimedia service is discontinued.

9. The apparatus of claim 7, wherein the service capability information is changed when the Radio Frequency (RF) communication scheme of the first user equipment is changed.

10. The apparatus of claim 7, wherein the service capability information is changed when the first user equipment delays a voice call service.

11. The apparatus of claim 7, wherein the service capability information comprises information about a supportable multimedia service.

12. The apparatus of claim 8, further comprising a display unit for displaying the changed service capability information of the second user equipment.

13. A method of providing service capability information by a first user equipment, the method comprising:
providing information regarding service capability to a second user equipment;
monitoring for a change in the service capability; and
transmitting, if a change in the service capability is detected, information regarding the change in service capability.

14. The method of claim 13, wherein the monitoring for the change in service capability comprises monitoring for a change in support of a multimedia service.

15. The method of claim 13, wherein the monitoring for the change in service capability comprises monitoring for a change in support of a Radio Frequency (RF) communication scheme.

16. The method of claim 13, wherein the monitoring for the change in service capability comprises monitoring for a delay in a voice call service.

17. The method of claim 13, wherein the information regarding the change in service capability comprises information about a supportable multimedia service.
